(19) United States
(12) Patent Application Publication
(10) Pub. No.: US 2008/0167962 A1
(43) Pub. Date: Jul. 10, 2008

(54) System and method for a customer loyalty program integrated into shopping cart checkout software and utilizing email marketing

(76) Inventor: Tabbatha Christie Lawe, Chapel Hill, NC (US)

Correspondence Address: TABBATHA LAWE, 101 Longwood Drive, Chapel Hill, NC, 27514, US

(21) Appl. No.: 12/004,935

(22) Filed: Dec. 21, 2007

Related U.S. Application Data
(60) Provisional application No. 60/878,584, filed on Jan. 4, 2007.

(51) Int. Cl. G06Q 30/00

(52) U.S. Cl. 705/14

(57) ABSTRACT

A system and method for operating a loyalty reward program integrated with a shopping cart checkout software through the buyer's online invoice and utilizing email marketing. A seller registers with the system and takes steps to integrate the loyalty system into the seller's shopping cart checkout software including the addition of HTML text placed in the shopping cart checkout software's online buyer invoice as a line item in the invoice. The reward offer is next presented to the buyer by the system in response to a call after a buyer clicks the link placed in the Online Buyer Invoice. Upon acceptance of the offer, registered by a click on the acceptance link, the shopping cart checkout software sends the buyer's relevant information from the Online Buyer Invoice to the loyalty reward web site. The system records the buyer acceptance of the loyalty invitation and calculates the appropriate reward due the buyer for opting-in. The system sends the calculated reward amount back to the shopping cart checkout software which revises the buyer's online invoice to account for the reward. The invention also stimulates repeat transactions by creating and sending marketing emails to the buyer's captured email address. Promotional offers in the email are made available for redemption only if the buyer opens the email or clicks on a link in the email. When making a repeat purchase, the opted-in buyer again clicks the reward offer presented as a line item within the online buyer invoice and again clicks the acceptance of the reward. The system evaluates the existing opted-in buyer's response. If the buyer has opened or clicked on links in the sent promotional email, the proper reward is calculated. If the buyer has not opened or clicked on links in the promotional email, the default opt-in reward offer is used. In either case, the proper reward is returned to the shopping cart checkout software to revise the buyer's repeat purchase online invoice with the available reward amount.

This application claims benefit of my provisional application 60/878,584 filed Jan. 4, 2007

### BACKGROUND OF THE INVENTION

1. Field of the Invention

This invention relates generally to systems and methods for rewarding buyers for repeat purchases. This invention is for a loyalty system integrated into a shopping cart checkout software program in the form of a discount offer imbedded in the buyer's final online invoice as a line item. Credit is given when a buyer opts-in to the seller's loyalty program and email list. The invention also stimulates repeat transactions by creating and sending email promotions with discounts available if the opted-in buyer opens or clicks a link in the email.

2. Background of the Invention

Customer loyalty programs involving rebates exist in many forms. These loyalty programs have the objective of attracting and retaining buyers for a seller under various economically efficient ways. A loyalty program can be uniquely designed and executed to best optimize the objectives of the seller while imposing appropriate major processes on the buyer all within the specific context of the buying/selling environment. The most familiar loyalty programs are those of airlines. Airline frequent flyer programs demonstrate highly optimized loyalty programs for their unique environment. Sellers, in this case the airlines, have created a loyalty system which tracks airline miles and/or segments flown for buyers. Many airline loyalty programs also automatically calculate miles awarded based on prices paid. Buyers, in this case passengers, are provided with specific mileage hurdles to achieve a reward. The rewards are generally granted automatically by airline loyalty systems when a buyer reaches the mileage hurdle. A buyer only has to request her free tickets or class upgrades to receive them. Buyers are not required to mail in proof-of-flight (e.g. ticket stubs). Moreover, tracking of flights is automated by the airline loyalty systems. The combination of major processes for an airline loyalty system include establishing mileage hurdles, automating tracking of miles and incorporating an automated redemption process for valuable rewards. Such a loyalty system exemplifies the kind of process optimization and system design within a unique business environment which all loyalty programs seek to encompass. Optimization comes in the form of both increasing seller revenue through additional sales to the same buyer, while minimizing seller costs by implementing the loyalty program in an efficient manner using systems.

Failures of a loyalty programs can also be traced to a disconnect between the major processes of the loyalty program and the environment in which the loyalty program operates. In most cases, the engagement process for the buyer is to complex or the tracking of the rewards is to onerous or the reward process is too involved for the buyer to warrant participation.

To those not schooled in the art, the variety of loyalty programs can be thought of like different compositions of a “virtual fastener.” Each loyalty program is intended to bind a buyer and a seller together over time under specific environmental conditions defined by when, how, and why a buyer purchases with the same seller. In this “virtual fastener” analogy, those not schooled in the art can perhaps understand how unique loyalty programs can be invented to optimize binding a buyer to a seller in specific environments. Likewise, one can easily understand that a specific glue chemical mixture can be created which is optimized to join different elements. Two pieces of a child's toy can efficiently be joined by a generic glue fastener, while an entirely different glue fastener would be required to efficiently join two parts on a space shuttle. These two different glue fasteners would naturally have entirely different properties and materials and each would clearly provide very different binding properties in the very different environments where they will bind two items. Likewise, as in the airline example above, loyalty systems can be designed an implemented using systems, software and reward mechanisms to optimize the binding of buyers and sellers within very specific environments.

One unique and challenging environment with an increasing need for effective loyalty between a buyer and a specific seller is retail selling on the Internet. The Internet selling environment is generally characterized by a relatively large number of sellers offering similar products to a geographically dispersed buyer base. A great deal of value has been created by companies who offer systems and services which allow a seller to acquire a customer through such vehicles as targeted banner ads, search marketing (e.g. Google Adwords) and marrying of content with marketing messages (e.g. Youtube). Yet, as the internet retailing environment matures, the idea of constantly utilizing systems and methods to acquire subscribers becomes a zero-sum game.

As buyer adoption rates for internet shopping flatten, sellers will begin to shift their focus to retaining customers rather than simply focusing on acquiring customers. Moreover, as the internet selling environment has matured, those schooled in the art are adopting various loyalty methods and systems to the unique environment.

For instance, this inventor filed patent application Ser. No. 10/060,910 to provide for the rewarding of a store credit for use in a second-purchase if the price of an item is found to be lower at a competitive retailer. This method also entails an email marketing campaign. Likewise, this inventor also filed patent application Ser. No. 10/755,847 which establishes the creation of a future store credit based on the completion of a purchase transaction. The future store credit can be used only if the buyer returns to make a repeat purchase. The repeat purchase is encouraged by the utilization of email marketing. The '847 method and system operate for a market venue. Approximately 70% of all internet purchase transactions are made by a buyer from a seller on a private web-site.

Accordingly, other methods and systems are established to design and create loyalty systems and methods optimized for specific internet sales environments. In application 60/690,359 this inventor created a method and system provided for a customer loyalty program utilizing a payment transfer agent and email marketing. Here, the reward processing utilizes the payment transfer agent to facilitate the reward administration.

One environment not yet covered in prior art is a reward program with email marketing which can be integrated into any buyer checkout flow through integration with the shopping cart software. Internet web-sites utilize software programs called “shopping carts” to track and assist in the transaction processing for internet sales between a seller and a buyer. Buyers “checkout” from a seller's web-site by clicking links and completing payment forms within the seller's checkout flow using the shopping cart software. The checkout flow is dictated in large part by the seller's shopping cart software. The shopping cart software can either be a piece of software loaded on the seller's server or can be a hosted application run from a remote server provided by a third party over the internet. Examples of shopping cart software which can be loaded on a seller's server include Miva Merchant, OSCommerce, Agoracart and Zencart. Shopping cart applications run on a remote server include those provided by Microsoft's Bcentral and Yahoo stores. Two payment transfer agents, Google Checkout and PayPal also provide shopping cart functionality as part of their payment services.

Examples of rewards program integrated into shopping cart software exist in the prior art. OSCommerce provides for two points/rewards modules. The first is described as:
“This module is so you can award points to your customer per assigned amount they spend. The points can then be redeemed at a specified value for specific products. You can mark points as pending, awarded, etc. You can manually award points and also points can auto-award after a designated number of days. You can also remove points for say order cancellation, return of items, etc.”
   The second is described as:
The purpose of this order total module is to provide a basic Customer Loyalty Program/Discount Scheme that rewards customers with discounts against each order based upon the amount they have spent in prior periods.
This module, at the time of a customer order being placed, totals up the value of all previous orders this customer has placed over a pre-defined (in admin) rolling period of time and then applies a discount rate to this order according to a table of discount rates also pre-defined (in admin) that correspond to the amount spent over the rolling period.
For example, in admin you have set the pre-defined rolling period to a month, and set up a table of discounts that gives 5.0% discount if they have spent over £1000 in the previous month (i.e. previous 31 days, not calendar month), or 7.5% if they have spent over £1500 in the previous month.

However, neither of these integrated rewards programs provide for subsequent email promotion to the buyer.

Yet another variation on integrating a system and method for stimulating additional, although not repeat, purchases into a shopping cart software comes from USPTO application 20060224464, which is a method and apparatus where a merchant server for an online seller provides an offer to a buyer for a subsidy from a second merchant. If the response indicates acceptance of the offer, then the subsidy is applied to the items purchased. The proposed method and apparatus provides for the discounting of an online purchases and the interaction of a seller's checkout flow with an external system. While this method can lower the effective price for a buyer, it does so by stimulating a second sale from a second party. This method also does not anticipate the email marketing functionality which is critical in driving repeat purchases.

Other loyalty options exist for rewarding a buyer with points or credits for future purchases. This inventor also has patent application Ser. No. 10/060,910 which provides for the rewarding of a store credit for use in a second-purchase if the price of an item is found to be lower at a competitive retailer. This method also entails an email marketing campaign.

The importance of intercepting the buyer at the point-of-checkout is one of the best options to invite the buyer to join a loyalty program for the seller. There are many options for inviting a buyer to join a loyalty program for a buyer, however, tying the invitation to an offer of a current credit against the purchase or future store credit provides an incentive for the buyer to accept the invitation. Providing the invitation with a credit offer directly on a line-item in the final invoice for the buyer is a powerful combination which will both seek and offer incentives for the buyer to join the loyalty program and opt-in to the email list. No other loyalty offer is integrated into the invoice as a credit line-item. Combining the acceptance to the loyalty program with the express opt-in email list acknowledgement makes for a powerful Internet retailing is also defined by the opportunity to market to buyers via email promotions. Email marketing is a low cost method of promoting a seller's items to a buyer. Email marketing within the internet retail environment has evolved such that a seller is required by law or by common practice to request a buyer's permission to send emails to the buyer. This is known as gaining express opt-in permission. Generally, buyers provide opt-in permission at a very low rate when prompted, except in the case where the buyer is receiving some form of compensation for granting opt-in permission. MyStoreCredit.com claims that the industry average for opt-in permission without offering compensatory incentives averages 1-4%, while MyStoreCredit's Loyalty program offers a compensatory reward to buyers for granting opt-in permission through the form of a future store credit. MyStoreCredit claims an 18% email opt-in rate when a reward is offered with the opt-in. Thus, providing some initial form of compensation to a buyer for opting-in to a seller's email marketing program has proven to be highly efficient.

Email marketing has evolved on the internet and is becoming heavily influenced by the general state of internet marketing. The vast majority of internet marketing is based on pay-for-performance. For example, Google has built a public company with a market cap close to $200 billion dollars by nearly exclusively offering pay-for-performance advertising via pay-per-click ads. Pay-for-performance in the email marketing sphere generally means payment is made for emails which are delivered. However, the ability to track emails which are both delivered and opened is becoming more feasible. This provides for the ability for a new method for email marketing with a rewards program where a specific reward can be utilized only if the buyer has either opened the seller's email promoting the reward offer or clicked-thru to the seller's website from a link in the opened email.

With any buyer reward program, cannibalization of sales is a concern by the seller when the seller offers a reward specifically to stimulate a repeat purchase. If the buyer would have made the repeat purchase without the offered reward, the seller has created a cost without a net corresponding growth in sales. It therefore becomes very important for a seller to optimally match a reward offer to a new purchase. The more clarity and assurances provided by a system or method to demonstrate that a buyer made a purchase stimulated by a reward offer, the more value the seller will find in the reward program.

Internet retailing can also be characterized by the speed and automation expected by buyers and sellers. This is important because in the internet retail context buyers will not tolerate being required to mail in coupons or having to wait long time periods for to receive promised loyalty benefits offered by internet retailers. In a traditional retail loyalty program, buyers often must mail in rebate forms or receipts. Buyers joining an internet loyalty program would expect to have automated processes such that the buyer does not have to be engaged in mailing forms or otherwise executing significant activities to receive his/her promised loyalty reward. The time expectations for rewards are also very different for an internet retailing model. Time expectations are measured through instant or near-instant rewards versus accumulating rewards for traditional retail loyalty programs. This time element is critical to the internet retailing environment. A buyer in an internet retail environment has come to expect nearly instant response to their actions. Thus, an internet retail loyalty program must also provide for nearly immediate rewards and the integration into the checkout flow provides for this speed.

Finally, internet retailing can often be characterized by sellers who operate on low margins. Because of the price-driven environment explained earlier, the internet seller often operates on extremely low margins. eBay.com has published analysis which shows that items for sale on eBay are generally 30% below the price for similar items at other ecommerce sites. Overstock.com and Amazon.com both publicly inform investors that their strategies are to offer items at cut-rate prices. Such aggressive pricing limits gross margin dollars available to fund any overhead expense such as a loyalty program. Moreover, it is likely that the internet retailer, and especially the smaller internet retailers, will not have the financial resources to staff and operate his/her own loyalty program. Nor do these internet sellers have the financial resources to pay overhead or fixed expenses for a loyalty program. The seller's financial constraints favor a pay-for-performance driven and variable expense loyalty program. Thus, a loyalty program optimized for the internet would be best implemented if it was variable cost driven and provides rewards commensurate with the spending made by the buyer. In this environment, it is critical that any loyalty program operate with a minimum of overhead expense, be primarily variable cost and require virtually no additional headcount or infrastructure to operate for an internet seller and be progressive so a seller incurs larger rewards only after additional buyer purchases—all within a context of attracting as many buyers to the reward program as possible. Such a loyalty program would also pay-out rewards and incur costs for the seller upon transactions executed by a buyer.

### OBJECTS AND ADVANTAGES

Accordingly, several objects and advantages of my invention are providing any number, or type, of internet sellers with a simple, readily understandable loyalty method and system where a buyer can opt-in to a seller's loyalty program and email list from clicking a link within the buyer's shopping cart software invoice and proactively accepting a reward in the form of a discount or future store credit based on the purchase amount of the shopping cart software invoice and subsequently the buyer can receive additional rewards on future purchases from the same seller across any market venue or ecommerce site when the buyer clicks the link in the shopping cart software invoice prior to final payment of the purchase. The buyer's participation in the loyalty program is based on the buyer's email address entered into forms on the shopping cart checkout software used to establish the final invoice for the buyer. Moreover, the ability to use a subsequently offered reward only if the buyer opens and/or clicks-thru from an email sent to the buyer ensures that emails to the buyer will be valued as long as the seller offers the loyalty program and also ensures that the seller is not inadvertently rewarding buyers for repeat purchases that would have occurred without the email prompting the buyer to return to the seller's site. The placement of the opt-in request as a line-item in the invoice for the buyer is central to the invention because it allows for a prominent and obvious placement to offer buyer's the chance to opt-in to the seller's loyalty program in return for a clear, unambiguous immediate reward for acceptance/opt-in. Specifically, when a buyer is checking-out for an online purchase, and is presented with an invoice showing their sub-totals, shipping and tax payments, this invention places a link directly in a new line item on that invoice showing the potential for a credit to be applied as a discount on the invoice if the buyer confirms their participation in the seller's loyalty program. The loyalty program is designed such that all software and operations are centralized requiring only seller internet access. Further, the loyalty program is designed to operate separately or from within the shopping cart checkout software which allows for simplicity of use by the seller and can be used on any website using the participating shopping cart checkout software. The elements of the loyalty program are designed to be a variable cost for the seller and rewards are progressive so sellers incur expenses commensurate with the buyer's transaction activity.

### SUMMARY OF THE INVENTION

The preferred embodiments of the present invention provide a system and method for a loyalty system integrated into any shopping cart checkout software program to create and administer a buyer credit offer imbedded as a line item similar to a tax or shipping line item in a buyer's online payment invoice. The credit offer is made as a reward to join the seller's loyalty program and opt-in to the seller's email list. Upon clicking the imbedded link a widow-window is opened and the offer is made to the buyer. Buyer's can accept or reject the offer by clicking either of two links. Upon clicking either link, an API call is made to the buyer reward database which determines the proper credit amount to return. The invention also stimulates repeat transactions by creating and sending email promotions to the buyer promoting the seller's message. The promotions in the email are only available as discounts on subsequent purchases if the buyer opens the email or clicks on the email. which are used only if the opted-in buyer opens or clicks a link in the email.

The loyalty system includes software and systems for a seller to establish her account within a seller database on the loyalty system using account creation software. Separately, the seller sets their shopping cart checkout software to engage the loyalty system.

During registration, the seller is also asked to select the frequency of time for marketing emails to be sent to the seller's opted-in buyers. Frequency may be one or more choices.

When setting their shopping cart checkout software to integrate with the loyalty system, the seller authorizes the shopping cart checkout software to insert a loyalty reward offer directly into the invoice created as part of the shopping cart checkout software's normal operation. In the preferred embodiment, the loyalty reward offer is made as a hypertext mark-up language (HTML) link series of question marks in the currency column on the invoice shown to the buyer the same way as a tax or shipping line item amount is shown. When the buyer clicks on the link, two actions happen. First, the buyer is presented with a widow-window inviting the buyer to join the seller's loyalty program and to opt-in to the seller's email. Two links are provided in the widow window and the buyer is requested to click one of the two. Buyers do not have to click the invitation link to allow the shopping cart checkout software to continue. The second thing which happens when the buyer clicks the invitation link is the shopping cart checkout software sends an API call over the internet to the loyalty system. The API call includes relevant buyer transaction information including the buyer's email address, the total amount of the purchase, and the description and web address for the items in the buyer's shopping cart. When the API call is received by the system, the system captures the item information and evaluates the received information by searching its database for a match to the submitted email address. If the email address is matched, the system next looks up the buyer's record using the email address and determines what discount the buyer is entitled to. If the system determines no match is made, the buyer data is added to the database as a new buyer record and the system determines the minimum reward amount. After determining the reward amount, the system returns an electronic message to the shopping cart checkout software including a negative number which represents the determined reward amount. The negative number is accepted by the shopping cart checkout software and is included in the buyer's invoice as a credit against the total price so the buyer sees a new re-calculated total that accounts for the returned reward amount, after which the buyer can continue as they wish.

The loyalty system periodically, such as once per day, executes a create marketing emails software program as part of its operation. Opt-in permission for sending email to a buyer is recorded by the system upon receiving the signal from the buyer's click on the invitation widow-window when a buyer accepts the invitation and agrees to the rules presented in the widow window. On a daily basis the outbound email system will evaluate if the opted-in buyer is due a marketing email based on the frequency of emails identified during seller registration. When thecreate marketing emails software executes, it will capture email addresses for buyers due for an outbound email in the upcoming period.

To prepare the buyer's outbound email, the create marketing emails software on the system will search the item captured description and links for the most popular items recorded in the information sent by the shopping cart checkout software during the API call. The most popular items which were not already associated with the buyer are identified and a link is created to those items and placed in the email. Moreover, the create marketing emails software attempts to match items to sell to the prior purchase according to key word and category matches. For instance, if the buyer has a prior purchase of a Golf club, the software will attempt to match seller items in the item available to sell database that have the words “golf” or “club”. In addition, the system will evaluate any category identifier for the prior purchase. Thus, if the prior item is identified in the category “golf clubs” the system will attempt to match seller items in the item available to sell database that are in the same branch of the category tree as “golf clubs.” If no items match the keyword or category, the system will insert seller's most popular items in rank order.

Once the items available to sell are identified, the create marketing emails software compiles the email for the targeted buyer by compiling pre-determined text fields and data relating to the buyer's next expected reward discount percentage with the items available to sell into an email format and sends the email. The system then sends the completed email to the email address used by the buyer on the payment transfer agent system.

The items available to sell are presented in the email as active HTML links. The combination in one email of the predetermined text, the clear reminder of the next reward discount reward level and the inclusion of HTML links to available items acts as a powerful marketing message to stimulate buyer response as recorded by a buyer click-thru. A buyer click-thru occurs when the buyer clicks on the item available HTML link in the email.

In the preferred embodiment of the invention, the reward offer is made contingent on the email being opened and/or the buyer clicking thru from the email to the seller's website. The system records the opening of the email by an appropriate means.

In one embodiment, the appropriate means is through the inclusion of at least a 1 pixel image graphic which is called by the buyer's email reader from the system's website. When the pixel image is called, the system records that the email was opened. Likewise, the system records a click on any link in the email by inserting a tracking process into the HTML code for the link. When the buyer clicks the link, the tracking code causes the system to record that the link was clicked. If either or both of these actions are recorded, the discount offer is available to the buyer.

Subsequently, if the system receives an API call from the shopping cart checkout software which includes indicators for an opened and/or clicking buyer's email address, the system will calculate the appropriate discount reward based on the buyer's activated email offer and return that reward amount back to the shopping cart checkout software for proper accounting. If the system receives an API call from the shopping cart checkout software which includes indicators for a previous buyer's email address who has not clicked or opened a sent email, the system will calculate the appropriate discount reward based on the default minimum reward offer and return that reward amount back to the shopping cart checkout software for proper accounting. In this way, buyers who open a sent email and/or click on a link in the sent email will receive the specific offer made by the seller in the email. If the email is not opened or the link in the email is not clicked, the buyer does not receive the specific offer from the email

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level architectural drawing illustrating the primary components of a Customer Loyalty Reward System integrated into shopping cart checkout software and utilizing email marketing to reward buyers for shopping and reading emails.

FIG. 2 is a block flow diagram illustrating the method in accordance with the invention.

FIG. 3 is a diagram of information for a seller account record for use with one embodiment of the present invention FIGS. 4a-d are samples of how the loyalty program integrates with the shopping cart checkout software and online buyer invoice.

FIG. 5 is a diagram of information for a buyer account record for use with one embodiment of the present invention.

FIG. 6 is a block flow diagram illustrating the marketing email creation method in accordance with the invention.

FIG. 7 is a sample marketing email for use with one embodiment of the present invention.

### DETAILED DESCRIPTION OF THE PREFERRED EMBODIMENT

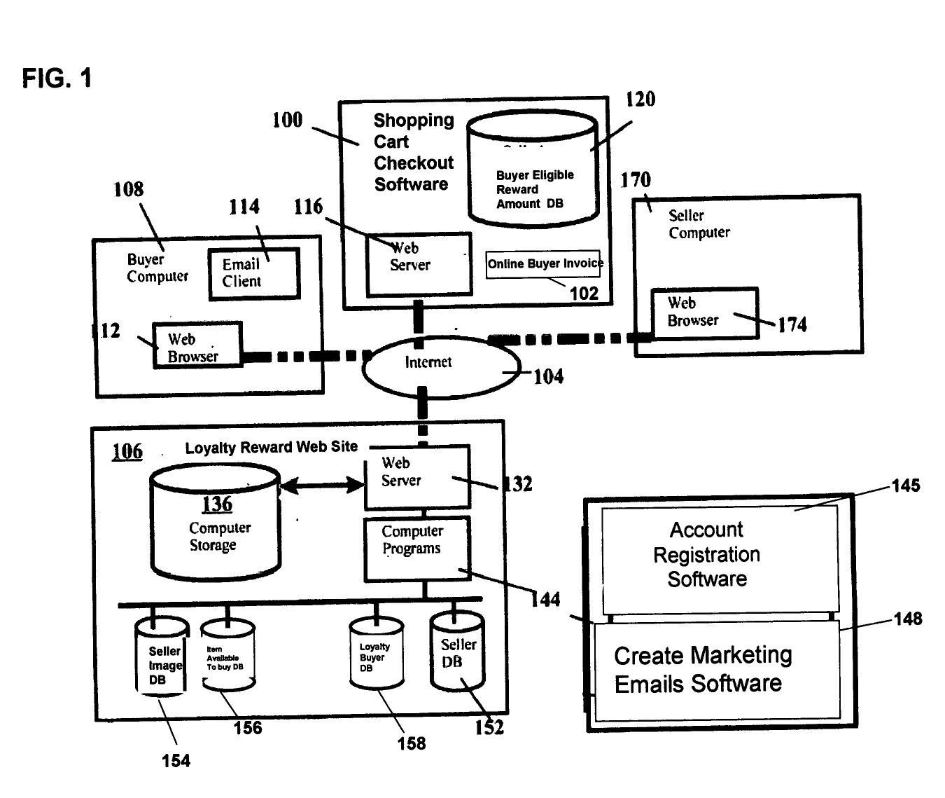

FIG. 1 is a high-level architectural drawing illustrating the primary components of a customer loyalty program integrated into shopping cart checkout software and utilizing email marketing. The loyalty reward system includes a buyer computer 108, a shopping cart checkout software 100 capable of producing an Online Buyer Invoice 102, a seller computer 170 and a loyalty reward web site 106, all of which are linked together by the Internet 104.

The buyer computer 108 may be any type of computing device that allows the buyer to receive and respond to emails via an email client 114 and interactively browse Web sites via a Web browser 112. For example, the buyer computer 108 may be a personal computer (PC) that runs the Windows NT operating system and Netscape Navigator and which can access the Yahoo Mail email service at Yahoo.com.

The preferred embodiment of this invention is a system and method for use with the Internet 104, a widely known global computer network. This invention is, however, not limited to the Internet. Thus, as used herein, the term “network” refers to any distributed computer network whether it be a local area network (LAN), a wide area network (WAN), or an Intranet.

The shopping cart checkout software 100 is software which can present an online invoice to a buyer. Shopping cart checkout software 100 can either be a piece of software loaded on a local computer server for a seller or can be a hosted application run for the seller from a remote server provided by a third party over the internet. Examples of shopping cart software which can be loaded on a server include Miva Merchant, OSCommerce, Agoracart, Xcart and Zencart. Shopping cart applications run on a remote server include those provided by Microsoft's Bcentral, eBay's ProStores and Yahoo stores. Sellers can also use payment transfer agents such as Google Checkout or PayPal for their shopping cart checkout software. The Online Buyer Invoice 102 is a web-based form written in hyper-text mark-up language that is created by the shopping cart checkout software in its normal course of operations and is presented to the buyer at the time of checkout. The Online Buyer Invoice 102 is electronically presented by the shopping cart checkout software 100 to the buyer's computer 108 through the buyer browser 112 over the Internet 104. The buyer uses the web browser 112 to view and interact with the Online Buyer Invoice 102. In the preferred embodiment of the invention, the Online Buyer Invoice 102 used in the system includes a unique line item in the invoice, similar to the unique tax or shipping line items. The unique line item extends an invitation for the buyer to join the seller's reward program. The line item presents the invitation in the form of a hypertext link optimally as question marks, placed within the same column within the Online Buyer Invoice 102 as the cost of the items being purchased, and any taxes owed and any shipping costs owed for the transaction being paid for by the buyer.

The loyalty reward web site 106 advantageously includes a web server 132 and computer storage 136, a seller account database 152, a seller image database 154, an item available to buy database 156, a loyalty buyer database 158 and multiple computer software programs 144.

The seller computer 170 may be any type of computing device that allows the seller to interactively browse Web sites via a Web browser 174. For example, the seller computer 170 may be a personal computer (PC) that runs the Windows 2000 operating system running Internet Explorer.

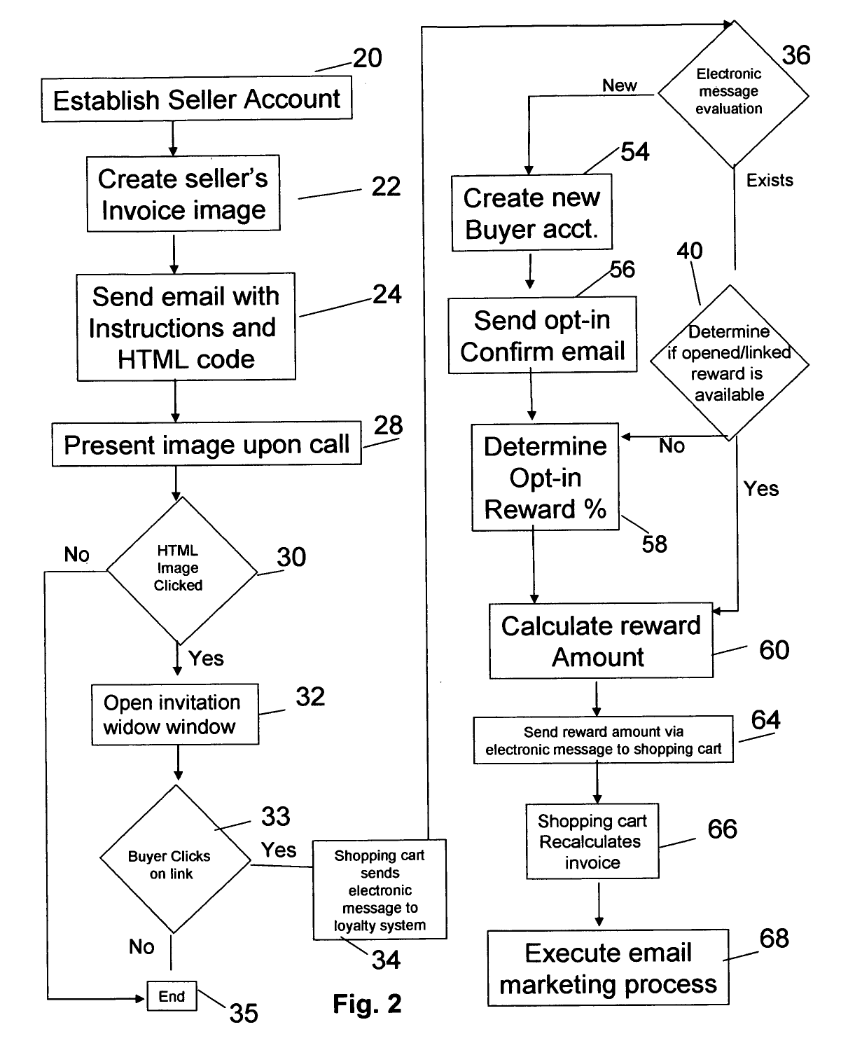

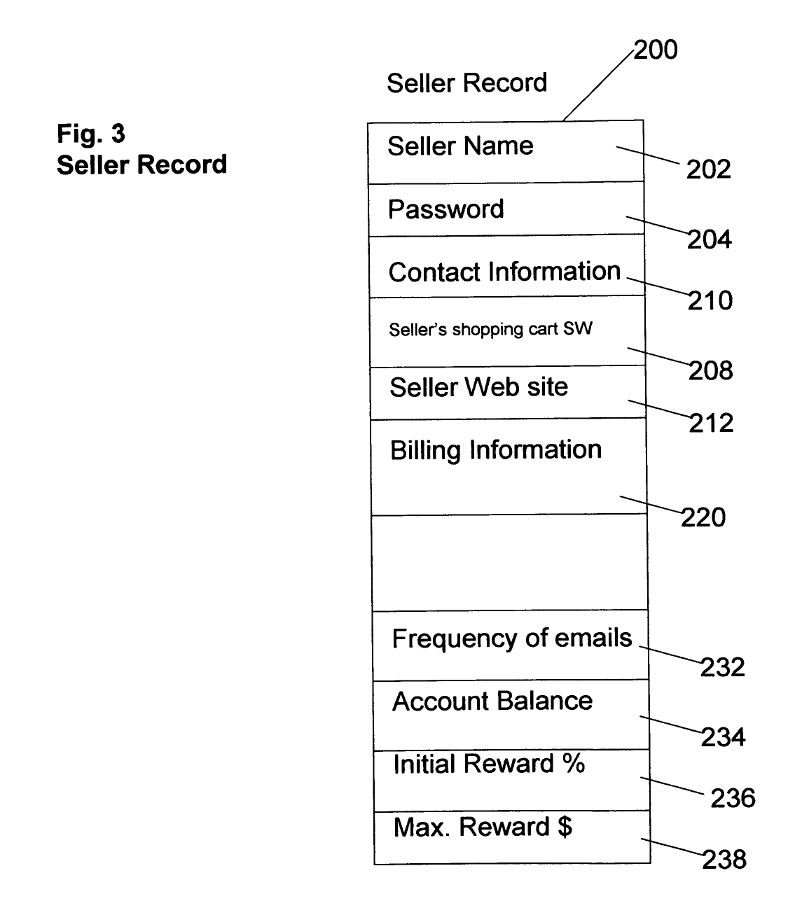

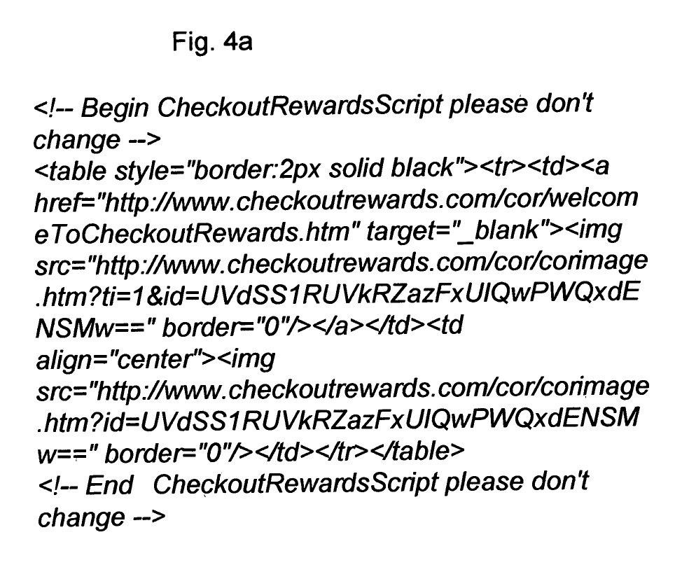

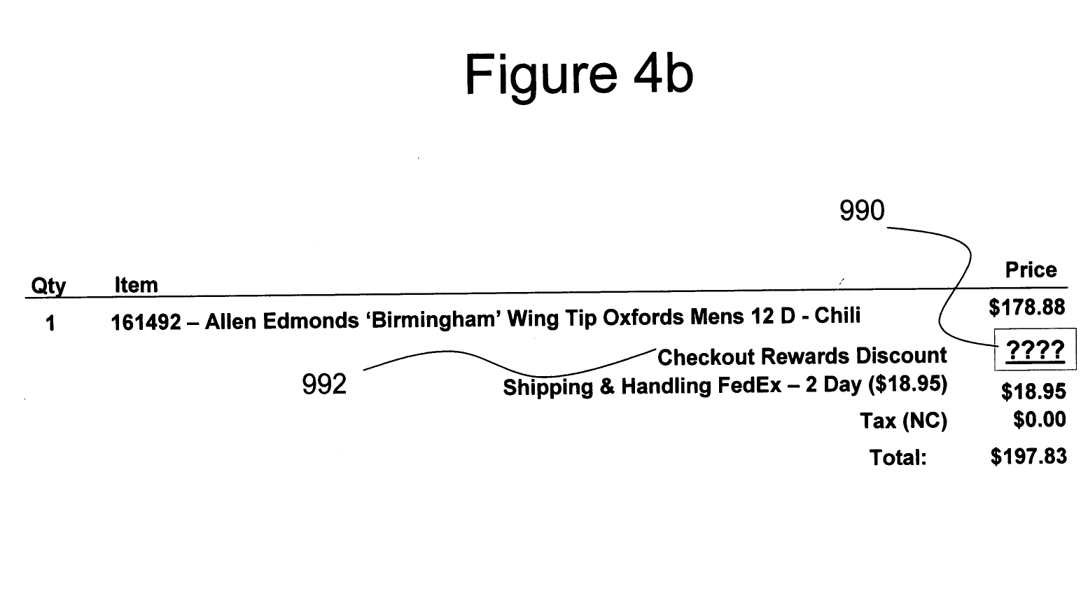

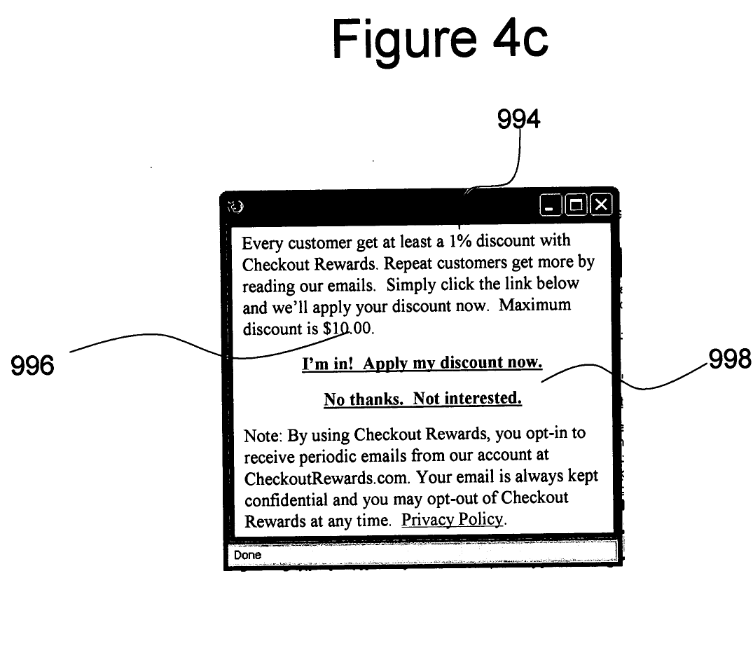

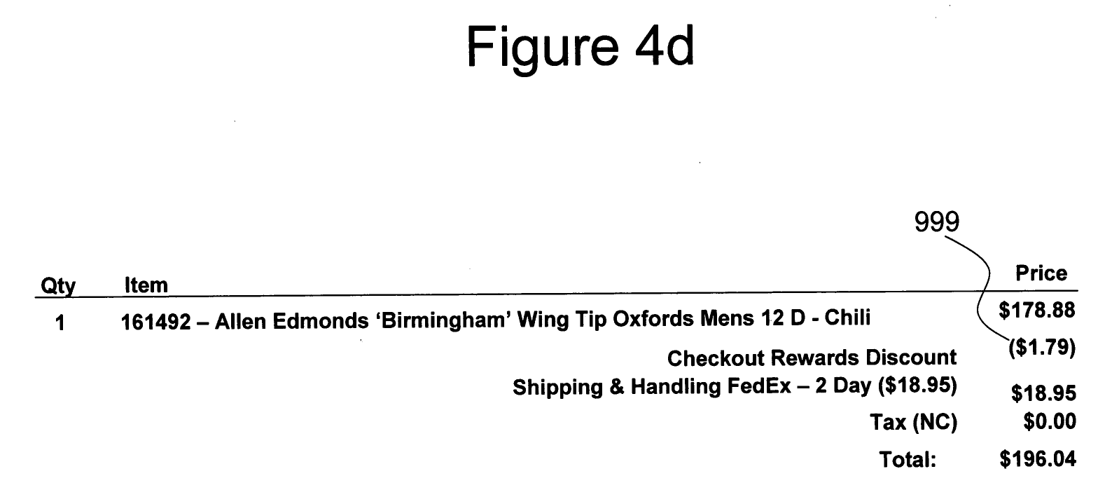

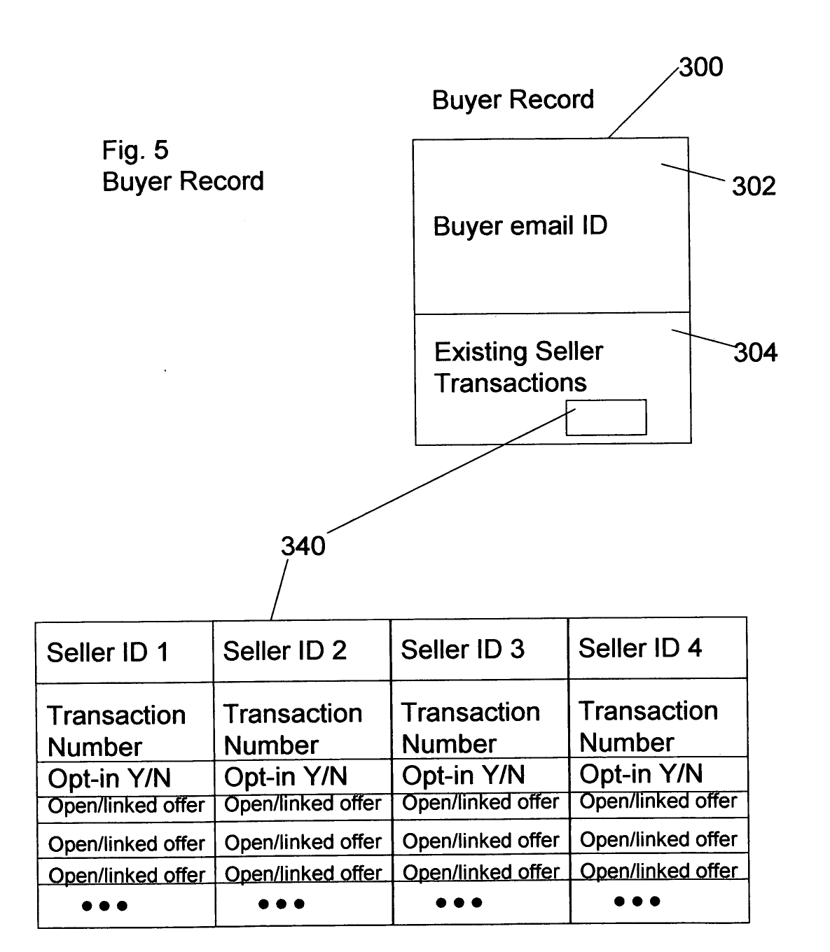

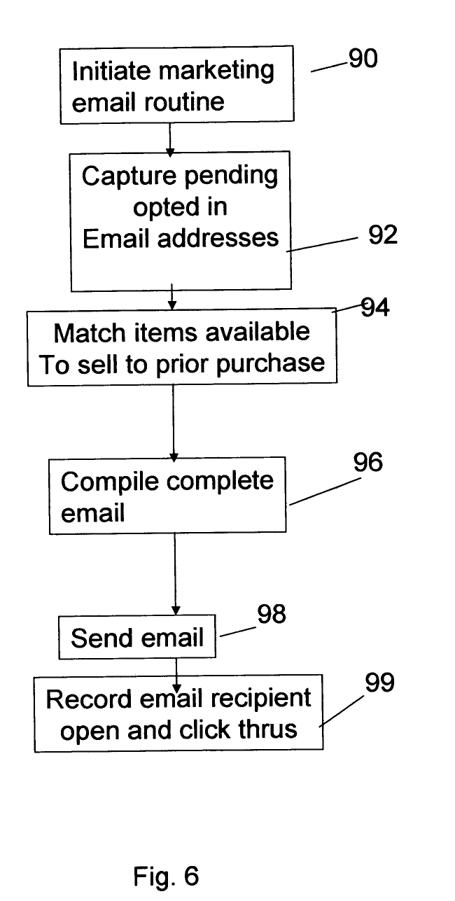

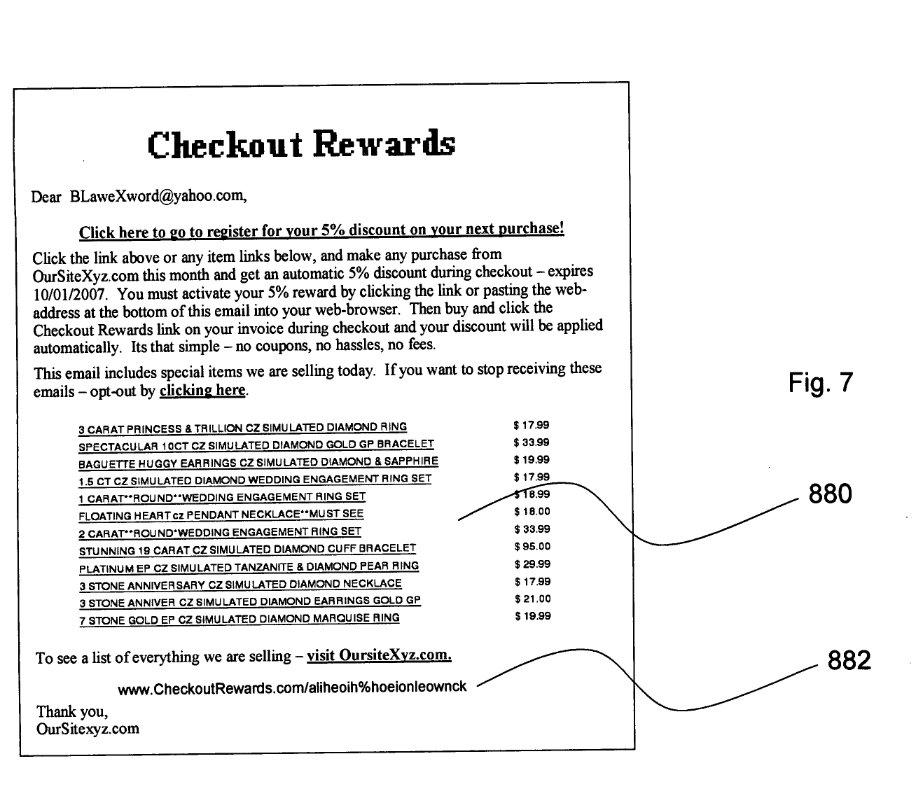

FIG. 2 is a general flow diagram of the method of this invention. Referring to this figure, establishment of a seller account is initiated at Step 20. Creation of a seller account includes the seller inputting seller account information such as name, address, billing information, selecting the frequency of opt-in emails, selecting the reward discount percent to offer to buyers who opt-in to the seller's reward program, and recording the seller's shopping cart checkout software into a seller unique database record (FIG. 3) housed on the loyalty system's seller database 152 using the account registration software 145.

FIG. 3 is a diagram of information for a seller account record for use with one embodiment of the present invention.

Next, at step 22, the system creates unique HTML code for the seller to present within their Online Buyer Invoice 102 within the seller's shopping cart checkout software 100. A sample of HTML code can be found in FIG. 4a. The HTML code allows for a link (FIG. 4b, 990) to the loyalty system directly from within the Online Buyer Invoice 102. FIG. 4a is a sample of the HTML code and FIG. 4b is a screen display of the Online Buyer Invoice 102 with the invitation offer included as a line item imbedded in the invoice.

At step 24, the system sends an email to the registering seller with the HTML code and with instructions on integrating the loyalty program into the seller's registered shopping cart checkout software. The participating providers of shopping cart checkout software 100 will have made previous enhancements to their software to allow for integration with the loyalty reward website 106. It is expected that different shopping cart checkout software providers will require different methods for a seller to integrate the loyalty service into their checkout process and the emailed instructions sent to the registering seller will provide explicit instructions for the shopping cart checkout software 100 as indicated by the seller during the seller's registration. The combination of the HTML code (FIG. 4a) and the instructions provide the seller with the necessary information to complete the integration of their chosen shopping cart checkout software 100 with the loyalty reward web site 106 so the Online Buyer Invoice 102 presented to a buyer through the shopping cart checkout software becomes properly integrated with the loyalty service.

As shown in FIG. 4b, the Online Buyer Invoice 102 created by the shopping cart checkout software 100 includes a line item within the Online Buyer Invoice 102 showing descriptive text (992) displaying the name of the rewards program and relaying the potential of a reward followed by the html link (990) embedded in the column with the other numbers for the invoice. In the preferred embodiment, the shopping cart checkout software 100 presents the descriptive text (992) and html link (990) after the buyer has entered their personally identifying information but before the buyer has completed the purchase.

The seller places the HTML text (FIG. 4a) in to the appropriate location as instructed for their shopping cart checkout software 100. Alternatively, the system can automatically place the HTML text into the seller's Online Buyer Invoices 102 for hosted or payment shopping cart checkout software providers.

In step 28, upon the first buyer web browser 112 directed by a buyer to the integrated Online Buyer Invoice 102, the shopping cart checkout software 100 presents the image offer within the buyers invoice (FIG. 4b). In the preferred embodiment, the graphic link portion of the invitation is in the form of series of question marks. The question marks relay the potential for a change to the current invoice.

At step 30, the system waits for a buyer to click on the presented image link (990). If the image link is never clicked, the system takes no action.

If the buyer does click the presented image link (990), the system moves to step 32. In step 32, a widow window is opened and populated with a web page from the web server 132 on the loyalty reward web site 106. FIG. 4c is a sample widow window shown to the buyer.

The widow window (FIG. 4c) presents the invitation offer to the buyer. The invitation includes the reward offer in the form of an immediate percent discount (994). This reward offer is set by the seller on the loyalty reward web site 106 within the seller record (FIG. 3) in the field for initial reward percent 236. This discount percent is set by the seller at registration or subsequently can be updated by the seller after the seller's account is registered. In an alternative embodiment of the invention, the reward offer can include a future store credit rather than an immediate discount for the reward if the buyer joins the seller's reward program. The alternative future store credit can either be a percent or fixed dollar amount.

In addition to the reward discount (994), the presented widow-window (FIG. 4c) includes fixed text explaining the reward offer and the benefit to the buyer for participating in the seller's loyalty program. The text also describes any maximum available reward amount (996). The maximum available reward is also established by the seller at the time of registration or can be updated after the seller's registration and is represented on the seller database 152 in the seller's record 200 (FIG. 3) in the maximum reward amount field 238.

The widow window (FIG. 4c) also includes two links (998) which provide a mechanism for the buyer to accept the invitation or reject the invitation.

In step 33, the system waits for the buyer to click on either of the two provided links. If the buyer chooses the negative or “no thanks” link, or if the buyer simply fails to click on a link, the system moves to step 35 and ends. If the buyer chooses the positive or “apply my discount now” link, the system moves to step 34 and the shopping cart checkout software 100 sends an electronic message to the loyalty reward web site 106 over the internet 104.

The electronic message includes relevant data for the buyer transaction represented in the shopping cart checkout software Online Buyer Invoice 102, including the buyer email address, item purchase price(s) and the description and web address for the item(s) in the buyer's shopping cart as well as any other relevant information such as time and date of message receipt. The system captures the purchase price and the description and web address for the item(s) in the buyer's shopping cart and places those data elements into the item available to buy database 156 within the loyalty reward web site 106.

At step 36, when the electronic message is received at the loyalty reward web site 106, the system captures the information and evaluates the received information by searching its database for a match to the submitted buyer email address. If the buyer email address is matched, the system moves to step 40 to determine if an opened/linked reward offer is available. Step 40 includes the system looking up the buyer record 300 on the loyalty reward web site system 106 and determining if there is an open/linked offer available in the seller record 340 for the buyer. If a buyer has opened an email sent by the message to the buyer and/or linked on a link in the email, the offer becomes active in the open/linked offer available field under the seller ID in the buyer record 300 on the buyer database 158. If an opened/linked offer is available, the reward percent is then carried to step 60. If no opened/linked offer is available, the system moves to step 58 and determines the opt-in reward percent by accessing the seller record 200 and capturing the initial reward percent field 236.

Alternatively, if during step 36 the buyer email address is not matched, the system moves to step 54 and a new buyer record (FIG. 8, 300) is created on the loyalty buyer database 158 on the loyalty reward web site 106. Next, the system moves to step 56 and sends an opt-in confirmation email to the buyer's received email address. Next, the system moves to step 58 and determines the opt-in reward percent by accessing the seller record 200 and capturing the initial reward percent field 236.

At step 60, the reward is calculated for the buyer by multiplying negative one times the appropriate reward discount percentage provided from Step 58 or Step 40 and multiplying that total by the item purchased sub-total amount from the electronic message received in step 36.

At step 64, the calculated reward amount is then sent by electronic message from the loyalty reward web site 106 back to the shopping cart checkout software 100. At step 66, when received, the shopping cart checkout software 100 accepts the electronic message and re-calculates the invoice by including the reward amount in the total for the buyer. The buyer's new invoice total thereby reflects the appropriate reward directly within the Online Buyer Invoice 102 (999, FIG. 4d) provided in return for a buyer's participation in the seller's reward program. FIG. 4d represents the updated Online Buyer Invoice 102 after the system completes its operation.

This placement of the offer invitation as a line item within the Online Buyer Invoice 102 (FIG. 4b) and the sequence of events presented concurrently with a sale is a critical element of the invention because the placement of the image within the invoice is a unique invention and increases the likelihood that a buyer will click one of the presented links (FIG. 4c 998). The more frequently buyers click the positive link, the more buyers accept the invitation and the faster the seller's opt-in email list will grow producing far more significant value for the seller than if the link was placed elsewhere on the Online Buyer Invoice 102.

The system next periodically creates marketing emails that are sent to the opted-in buyers. Step 68 identifies this step. Step 68 is further described by the diagram on FIG. 10.

Referring to step 90 in FIG. 10, on a periodic basis, such as once per day, the loyalty reward system 106 initiates an outbound email creation routine. After initiation, the create marketing emails software 148 captures buyer email addresses for opted-in buyers due a marketing email, step 92.

In the preferred embodiment, the seller pre-determines the frequency of emails to be sent to any opted-in buyer during the seller registration process, FIG. 2, step 20. For example, sellers can choose to have any opted-in buyer receive emails every 15, 30 or 45 days. Opt-in permission for a buyer is recorded when a buyer accepts the rules by clicking the positive link presented on the widow window (FIG. 4c, 998). By accepting the invitation to the loyalty program, the buyer is also providing opt-in permission to receive marketing emails from the seller's account on the loyalty reward web site 106. The marketing email software 148 determines the email schedule for each buyer to match the selected frequency of the seller's selection at registration as recorded in the seller's record 200, in field 232, on the seller database 158. Thus, a seller choosing 30-days for email frequency during registration establishes that each opted-in buyer will receive emails approximately once per month for 12 months. Thus, when the create marketing email software 148 executes, it will capture and prepare the information needed to execute buyer outbound marketing emails just for buyer email addresses due for an outbound email from an associated seller in the upcoming period.

FIG. 11 shows a sample outbound marketing email. To prepare the buyer's outbound email, the create marketing emails software 148 will gather matches from the seller's current items available to sell within the items available to buy database 156 to match against the prior item or items purchased by the buyer. The create marketing emails software 148 attempts to match items available to sell records for the targeted buyer's seller within the items available to buy database 156 based on a key word and/or category match or through a popularity match. For instance, if the buyer has a prior purchase of a Golf club, the software will attempt to match seller items in the item available to sell database that have the words “golf” or “club”. In addition, the system will evaluate any category identifier for the prior purchase. Thus, if the prior item is identified in the category “golf clubs” the system will attempt to match seller items in the item available to sell database that are in the same branch of the category tree as “golf clubs.” The system also ranks the popularity of items captured from all transactions received from the seller's shopping cart checkout software 100 in the electronic message described in step 34, FIG. 2. Items captured more frequently or items being sold with the original buyer's purchase receive higher popularity scores in the items available to buy database 156. For example, if 100 opted-in buyers all made initial purchases which included a golf-club, but 50 of those buyer transactions also included “golf balls” within the same Online Buyer Invoice 102, then the system would rate “golf balls” as a highly popular item for buyers who have previously purchased “golf clubs.” The create marketing emails software 148 will therefore include an HTML link from the items available to buy database 156 for items available with the term “golf balls,” into the marketing emails being created and sent to the remaining 50 buyers who previously purchased golf clubs but not golf balls. In this way, more popular items are shown in the email. The matching and selection process is reflected in step 94.

Alternatively, the system can dynamically search a seller's items available to sell by visiting the seller's ecommerce web site or placing a call to capture the seller's items available to sell at a market venue such as eBay.com

In step 96, once the appropriate seller's items available to sell are identified, the create marketing emails software 148 compiles the email for the targeted buyer by compiling pre-determined text fields and data relating to the buyer's next expected rebate percentage with the items available to sell into an email.

At step 98 the create marketing emails software 148 sends the compiled email to the buyer email address.

The items available to sell are presented in the email as active HTML links as shown in FIG. 11. The combination in a single email of the predetermined text, the clear reminder of the pending discount for purchase and the inclusion of HTML links to available items for sale acts as a powerful marketing message to stimulate buyer click-thru. A buyer click-thru occurs when the buyer clicks on the item available HTML link in the email.

The create marketing emails software 148 also contains a routine which records each buyer's opening and/or click thru of a link in the email, step 99. In step 99, when a buyer opens the email, an image of at least one pixel is called from the loyalty reward system web site 106 to the buyer's email client 114. The calling of the image signifies the opening of the email. The click-thru is recorded for the email by recording a buyer click on any of the HTML item links (FIG. 11, 880) or the buyer copying and pasting an html address (FIG. 11, 882) into their web-browser. When the buyer email is opened and/or the click-thru is recorded the reward for the buyer as determined in step 40, FIG. 2, is set to the one described in the reward offered in the email. If a buyer has opened an email sent by the message to the buyer and/or linked on a link in the email, the offer becomes active in the open/linked offer available field under the seller ID in the buyer record 300 on the buyer database 158. The addition of marking the reward as eligible upon the opening or click-thru for the email is an important element to the invention because it ensures that only buyers who have opened or clicked on a link are eligible for the specific offered reward. Sellers do not want to give rewards to buyers who would have purchased an item anyway without opening or clicking thru on the email.

When the buyer makes a repeat purchase using the seller's shopping cart checkout software 100, the transaction will follow from step 28, in FIG. 2.

It will be appreciated by those skilled in the art that numerous modifications and variations are possible, and that the invention may be practiced otherwise than as specifically described herein, without departing from the scope thereof.

I claim:

1. A loyalty reward system for facilitating rewards between a seller and a buyer involving a seller computer, a buyer computer, a shopping cart checkout software capable of presenting an online buyer invoice and a loyalty reward web site connected via a network, said loyalty reward system configured to:
(a) implement a process for said online buyer invoice to present a loyalty reward offer as a line item within the online buyer invoice,
(b) accept and record the buyer's click acceptance to said loyalty reward offer and acceptance of email opt-in by recording said buyer's transaction information from said online buyer invoice and said buyer email address,
(c) calculate an appropriate reward discount,
(d) apply the reward discount to the online buyer invoice.

2. The loyalty reward system of claim 1, wherein said loyalty reward offer is presented as a unique line item within the buyer invoice and the offer link is placed in the same column as the item price, tax and shipping amount.

3. The loyalty reward offer of claim 2, wherein said offer link is shown as at least one question mark presented as an HTML link.

4. The loyalty reward system of claim 1, wherein said loyalty reward system is configured to:
implement a process to create and send at least one marketing email message to said opted-in buyer email address, said email including an image trackable by the loyalty reward system upon the email being opened and including at least one HTML link linked to items for sale from the seller, said link recordable upon a click by the buyer.

5. The loyalty reward system of claim 4, wherein said marketing email message includes a reward offer which is applied to the online buyer invoice only if the loyalty reward system records the buyer has been opened or a link has been clicked prior to said buyer's click acceptance to said loyalty reward offer.

6. The loyalty reward system of claim 4, wherein said HTML link linked to items for sale from the seller, are determined in part by popularity of associated items received in all buyer transaction information.

7. An automated method, performed by a computer-based loyalty reward system, for facilitating a reward between a seller and a buyer as part of a transaction integrated into a shopping cart checkout software, the method comprising:
creating and presenting on a reward offer in an Online Buyer Invoice presented by said shopping cart checkout software,
accepting and recording the buyer's click acceptance to said loyalty reward offer and acceptance of email opt-in by recording said buyer's transaction information from said online buyer invoice and said buyer email address,
(c) calculating an appropriate reward discount,
(d) applying the reward discount to the online buyer invoice.

8. The method of claim 7, further comprising:
presenting the reward offer as a unique line item within the buyer invoice within the same column as the item price, tax and shipping amount.

9. The method of claim 8, further comprising:
presenting said offer link as at least one question mark presented as an HTML link.

10. The method of claim 6, further comprising:
creating and sending at least one marketing email message to said opted-in buyer email address, said email including an image trackable by the loyalty reward system upon the email being opened and including at least one HTML link linked to items for sale from the seller.

11. The method of claim 10, wherein said marketing email message are created including a reward offer which is applied to the online buyer invoice only if the loyalty reward system records the buyer has been opened or a link has been clicked prior to said buyer's click acceptance to said loyalty reward offer.

12. The method of claim 10, said HTML link linked to items for sale from the seller, are included by determining the popularity of associated items received in all buyer transaction information.
